(19) United States
(12) Patent Application Publication
(10) Pub. No.: US 2026/0131785 A1
(43) Pub. Date: May 14, 2026

(54) SYSTEMS AND METHODS FOR ADAPTIVE CRUISE CONTROL BASED ON ONLINE LEARNING PREFERENCE

(71) Applicant: Toyota Motor Engineering & Manufacturing North America, Inc., Plano, TX (US)

(72) Inventors: Ahmadreza Moradipari, Mountain View, CA (US); Rohit Gupta, Santa Clara, CA (US); Amr Abdelraouf, Redwood City, CA (US); Kyungtae Han, Palo Alto, CA (US); Sergei Avedisov, Mountain View, CA (US); Onur Altintas, Mountain View, CA (US); John Kenney, Santa Clara, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/944,774

(22) Filed: Nov. 12, 2024

(51) Int. Cl. B60W 30/14; B60W 50/00

(52) U.S. Cl. CPC B60W 30/143; B60W 50/0097; B60W 2050/0083; B60W 2520/10; B60W 2554/802; B60W 2555/20; B60W 2556/10

(57) ABSTRACT

A system and method for online learning adaptive cruise control (ACC) for driving a vehicle includes one or more non-transitory memories storing an ACC model pool comprising one or more ACC models, and one or more processors. The one or more processors operably causes the system to generate, using a trained meta algorithm and based on historical user inputs and user preferences of a user, one or more personalized ACC models associated with the user, and include the one or more personalized ACC models in the ACC model pool, determine whether the user triggers a real-time ACC disengagement, in response to determining that the user triggers the real-time ACC disengagement, select, based on real-time user inputs, a predicted ACC model from the ACC model pool including the one or more personalized ACC models, and engage the vehicle with the predicted ACC model.

### TECHNICAL FIELD

The present disclosure relates to systems and methods for vehicle driving assistance functions, more specifically, to systems and methods for personalized vehicle driving assistance functions using machine learning algorithms.

### BACKGROUND

Drivers have diverse driving styles, particularly when it comes to following other vehicles in traffic. Some may prefer a more aggressive approach with shorter following distances, while others may feel more comfortable with a conservative setup. Therefore, there is a need to generate personalized adaptive cruise control (ACC) settings that adjust a vehicle's advanced driver assistance systems to align with individual driver preferences.

### SUMMARY

In one embodiment, a system for online learning adaptive cruise control (ACC) for driving a vehicle includes one or more non-transitory memories storing an ACC model pool comprising one or more ACC models, and one or more processors. The one or more processors operably cause the system to generate, using a trained meta algorithm and based on historical user inputs and user preferences of a user, one or more personalized ACC models associated with the user, and include the one or more personalized ACC models in the ACC model pool, determine whether the user triggers a real-time ACC disengagement, in response to determining that the user triggers the real-time ACC disengagement, select, based on real-time user inputs, a predicted ACC model from the ACC model pool including the one or more personalized ACC models, and engage the vehicle with the predicted ACC model.

In another embodiment, a method for online learning ACC for driving a vehicle includes generating, using a trained meta algorithm and based on historical user inputs and user preferences of a user, one or more personalized ACC models associated with the user, and including the one or more personalized ACC models in an ACC model pool comprising one or more ACC models, determining whether the user triggers a real-time ACC disengagement, in response to determining that the user triggers the real-time ACC disengagement, selecting, based on real-time user inputs, a predicted ACC model from the ACC model pool including the one or more personalized ACC models, and engaging the vehicle with the predicted ACC model.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for personalized Adaptive Cruise Control (ACC) of an ego vehicle based on online learning preference of the present disclosure, according to one or more embodiments shown and described herewith;

FIG. 2 schematically depicts example components of the ego vehicle of the present disclosure, according to one or more embodiments shown and described herein;

FIG. 3 depicts an illustrative block diagram for generating personalized ACC settings of the present disclosure, according to one or more embodiments shown and described herein;

FIG. 4 depicts an illustrative block diagram for generating a personalized ACC setting using online learning preference of the present disclosure, according to one or more embodiments shown and described herein; and

FIG. 5 depicts a flowchart for generating personalized ACC settings using online learning preference for the ego vehicle of the present disclosure, according to one or more embodiments shown and described herein.

### DETAILED DESCRIPTION

This disclosure presents embodiments encompassing systems and methodologies tailored for generating personalized Advanced Driver Assistance Systems (ADAS), especially personalized Adaptive Cruise Control (ACC) using online learning preference. These systems and methods disclosed here enable the creation and updating of personalized ACC settings for drivers, taking into account their personal driving habits and preferences, and other relevant factors to enhance safety and comfort. By creating new ACC settings and incorporating them into existing ACC settings and default ACC settings for each individual, the disclosed systems facilitate adjustments to the ADAS settings through a meta algorithm enhanced engine based on existing ACC settings, thereby enhancing safety and comfort. Consequently, these systems and methods adapt the personalized ACC settings according to disengagement and engagement of ACC over time and adjust it based on evolving ACC settings, particularly through a model aggregator to predict a new ACC setting when the driver disengages from a current ACC setting. Further, the methods and systems disclosed herein reduce the disengagement of the ACC where models representing driver preferences can be selected from a model aggregator.

Throughout the disclosure, the Adaptive Cruise Control (ACC) refers to an Advanced Driver Assistance System (ADAS) that automatically adjusts the vehicle's speed to maintain a safe following distance from the vehicle ahead. The ACC systems may also integrate with other features, such as, without limitation, lane-keeping assistance. Various parameters and functions may be adopted in the ACC systems, such as, without limitation, set speed, following distance (in the form of actual distance or time-based distance), lane keeping assist (LKA), following speed, deceleration and acceleration limits, collision warning and avoidance, system status indicators, adaptive stop-and-go, override mechanisms, traffic sign and speed limit recognition, curve speed reduction, and the like. The ACC systems may include multiple ACC settings regarding these parameters and functions. Each ACC setting may include a different set of parameters and functions described above. The ACC models may be generated based on corresponding ACC settings. A personalized ACC model may be interchangeable to a predicted ACC model.

Throughout the disclosure, a gap, a following gap, or a time gap, refers to a distance between a following vehicle and a leading vehicle immediately preceding the following vehicle, or the distance divided by the instantaneous speed of the ego vehicle. A gap preference or a desired gap refers to the gap of the following vehicle tending to in steady state following, when the leading vehicle is traveling at a substantially steady speed. The preference gap can be a constant speed of the leading vehicle or vary with the speed of the leading vehicle.

As used herein, the singular forms “a,” “an” and “the” include plural referents unless the context clearly dictates otherwise. Thus, for example, reference to “a” component includes aspects having two or more such components unless the context clearly indicates otherwise.

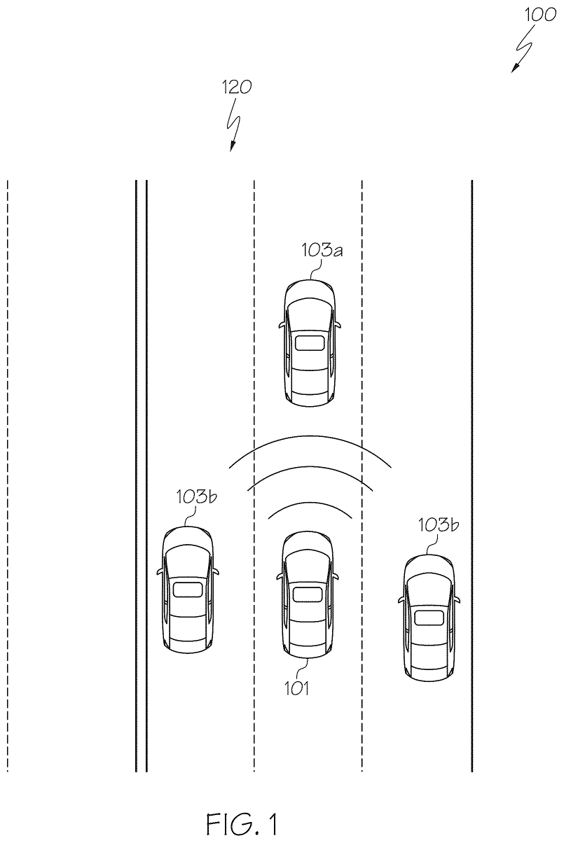

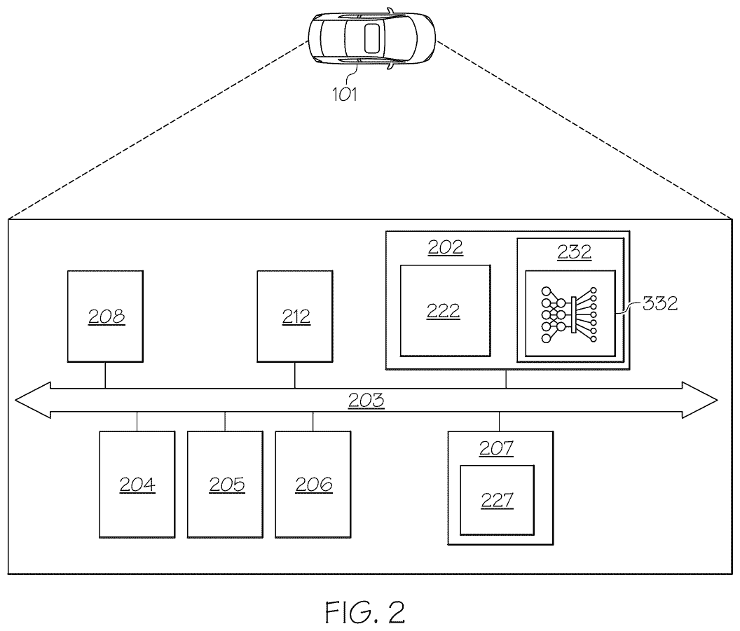

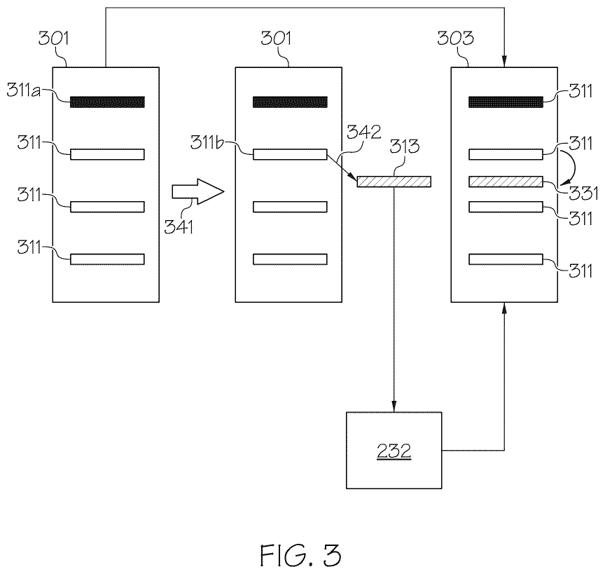

Referring now to figures, FIG. 1 schematically depicts an example online learning ACC system 100. The online learning ACC system 100 may monitor the ADAS system of an ego vehicle 101, such as engagement and disengagement of ACC, and collect user inputs and user preferences of a current driver related to ACC settings, such as, without limitation, speed setting/following speed, lane keeping, following distance, and the like, when a driver disengage from an ACC setting. The online learning ACC system 100 may use an online learning module 232 (as illustrated in FIG. 2) that includes a machine-learning (ML) algorithm, such as a meta algorithm, to generate one or more personalized ACC settings 331 (as illustrated in FIG. 3). The online learning ACC system 100 may then reengage the ACC at one of the personalized ACC settings 331 such that the driver can enjoy the engagement of ACC at the driver's personalized ACC settings. The ego vehicle 101 may use the one or more personalized ACC settings 331 for personalized real-time interference, such as updating gaps from adjacent vehicles 103 (e.g., a leading vehicle 103a and one or more side vehicles 103b), lane changing, and updating vehicle speed.

In embodiments, the ego vehicle 101 may be an automobile or any other passenger or non-passenger vehicle such as, for example, a terrestrial, aquatic, and/or airborne vehicle. The ego vehicle 101 may be an autonomous vehicle that navigates its environment with limited human input or without human input. The ego vehicle 101 may drive on a road 120, where one or more adjacent vehicles 103, such as the leading vehicle 103a, the one or more side vehicles 103b that are adjacent to the ego vehicle 101, may share the road 120 with the ego vehicle 101. Each of the vehicles 101 and 103 may include actuators for driving the vehicle, such as a motor, an engine, or any other powertrain. The vehicles 101 and 103 may move or appear on various surfaces, such as, without limitations, roads, highways, streets, expressways, bridges, tunnels, parking lots, garages, off-road trails, railroads, or any surfaces where the vehicles may operate.

In embodiments, the ego vehicle 101 may include one or more proximity sensors 208 (e.g., as illustrated in FIG. 2), and one or more vehicle steering sensors 212 (e.g., as illustrated in FIG. 2). The proximity sensors 208 and the vehicle steering sensors 212 may be used to collect and generate environmental data and vehicle steering data, such as a time gap and/or a distance gap between the ego vehicle 101 and the adjacent vehicles 103, the acceleration of the ego vehicle 101, the velocity of the ego vehicle 101, and the velocity of the adjacent vehicles 103, current location of the ego vehicle 101, contextual information, such as weather information, a type of the road on which the ego vehicle 101 is driving, a surface condition of the road 120 on which the ego vehicle 101 is driving, and a degree of traffic on the road 120 on which the ego vehicle 101 is driving. The environmental data may include weather conditions (e.g., sunny, rain, snow, or fog), road conditions (e.g., dry, wet, or icy road surfaces), traffic conditions, road infrastructure, obstacles (e.g., adjacent vehicles 103 or pedestrians), lighting conditions, geographical features of the road 120, and other environmental conditions related to driving on the road 120.

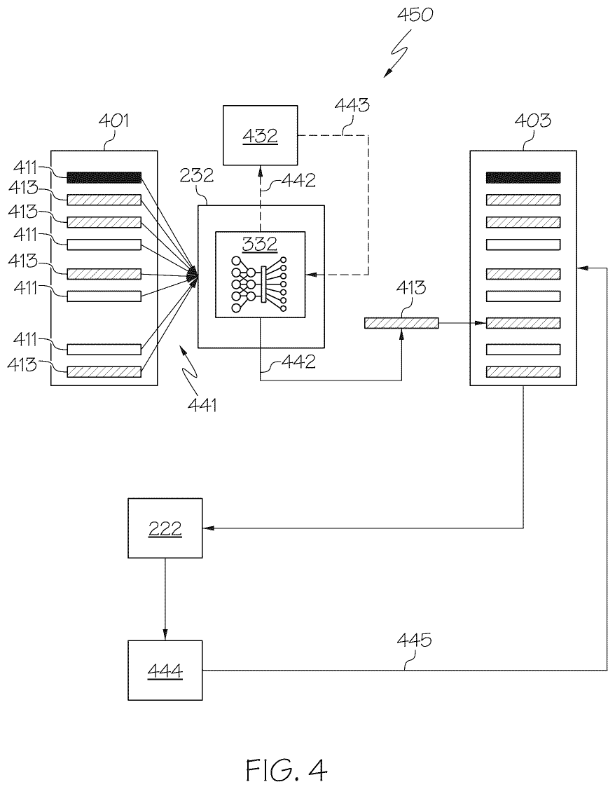

In some embodiments, the ego vehicle 101 may include an ADAS system. The ADAS system may include various safety features and technologies designed to assist users in operating the ego vehicle 101. The ADAS system may use various sensors, such as the one or more proximity sensors 208, and other technologies to detect undesirable hazards on the road 120 and provide warnings or take corrective actions to prevent accidents and/or undesirable user experiences. In some embodiments, the ADAS system may include subsystems, such as, without limitation, an ACC system to automatically adjust the speed of the ego vehicle 101 to maintain a desirable distance from the leading vehicle 103a, Pre-Collision System (PCS) and Automatic Emergency Braking to warn the user of an imminent collision with another adjacent vehicle 103 and/or obstacle and automatically operate the ego vehicle 101 to prevent or mitigate any undesirable impact, Lane Departure Warning and Lane Keeping Assist to alert the user if the ego vehicle 101 drifts out of its lane and/or apply corrective steering to keep the ego vehicle 101 within the lane, Blind Spot Monitoring and Rear Cross Traffic Alert to alert the user of the adjacent vehicle 103 or pedestrians in the blind spot area and/or in the rearview of a parking space or driveway, Parking Assistance to assist the user in parking maneuvers by automatically steering or braking. Each ego vehicle 101 may include an ADAS module 222 (e.g., as illustrated in FIG. 2) to operate the ADAS system, including the ACC system. In some embodiments, each ego vehicle 101 may further include one or more personalized ACC settings 331 operated by an online learning module 232 (e.g., as illustrated in FIG. 2) to tune the ACC system. The online learning module 232 may include one or more machine learning (ML) modules 332 to use one or more neural networks (in FIGS. 2 and 4).

In embodiments, the ACC system may include an ACC model pool 401 (e.g., as in FIG. 4). The ACC model pool 401 may include one or more ACC models 411 (e.g., in FIG. 4). In operation, the user or the ego vehicle 101 may select and engage an ACC model 411 from the ACC model pool 401 to maintain the ego vehicle 101 at a following speed and/or a flowing distance from the adjacent vehicles 103, e.g. the leading vehicle 103a, based on sensory data collected using the proximity sensor 208 and/or the vehicle steering sensor 212. The selected ACC model 411 may adjust the speed of the ego vehicle 101 to maintain a desirable following distance. For example, the ego vehicle 101 may continuously monitor whether a slower-moving vehicle is ahead using the proximity sensor 208 (e.g., in FIG. 2). After determining the leading vehicle 103a is present and moving slower than the ego vehicle 101, the ACC system can automatically reduce the speed of the ego vehicle 101 by applying brakes or easing off the throttle to maintain a desirable following distance. The ACC may reengage and accelerate back to the set speed when the road ahead clears. Each ACC model 411 (in FIG. 4) may include a unique combination of vehicle operation parameters at unique set values, such as, without limitation, a vehicle speed, a following distance, a deceleration limit, an acceleration limit, a minimum operation speed, vehicle operation mode selection, weather and road condition adaptation, and vehicle speed adjustments in curves. After an engagement of the ACC model, the user may disengage from ACC and manually drive the ego vehicle 101. For example, the user may press a button or press a brake pedal of the ego vehicle 101 to disengage.

FIG. 2 schematically depicts example components of the online learning ACC system 100. The online learning ACC system 100 may include the ego vehicle 101. The ego vehicle 101 may include one or more memory components 202, a communication path 203, one or more processors 204, input/output hardware 205, network interface hardware 206, data storage component 207, the proximity sensor 208, and the vehicle steering sensor 212.

The one or more processors 204 may be coupled to the communication path 203. Each of the one or more processors 204 may be any device capable of executing machine-readable and executable instructions. The instructions may be in the form of a machine-readable instruction set stored in the data storage component 207 and/or the memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like.

The communication path 203 may be formed from any medium that is capable of transmitting a signal such as, for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The one or more memory components 202 may be coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise one or more logic or algorithms written in any programming language of any generation (e.g., 1 GL, 2 GL, 3 GL, 4 GL, or 5 GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 204 along with the one or more memory components 202 may operate as a controller or an electronic control unit (ECU) for the ego vehicle 101. The one or more memory components 202 may include the ADAS module 222 and the online learning module 232.

The input/output hardware 205 may include, without limitations, a monitor, keyboard, mouse, printer, camera, microphone, speaker, and/or other device for receiving, sending, and/or presenting data. The input/output hardware 205 may include a user interface allowing the user to input or control the online learning ACC system 100 regarding user ACC preferences.

The network interface hardware 206 for communicatively coupling the ego vehicle 101 to any external devices or components. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the ego vehicle 101 may transmit its data to the online learning module 232.

The data storage component 207 may be communicatively coupled to the communication path 203 and store historical user inputs and user preferences 227. The historical user inputs and user preferences 227 may include historical parameters regarding the following gap, following speed, lane change, and any other ACC parameters.

The ego vehicle 101 may include one or more proximity sensors 208. The proximity sensors 208 may be used for determining distances to near objects and vehicles and capturing images or videos of the environment around the ego vehicle 101. In some embodiments, the one or more proximity sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the ego vehicle 101. The one or more proximity sensors 208 may include a forward-facing camera installed in the ego vehicle 101. The one or more proximity sensors 208 may be any device having an array of sensing devices capable of detecting radiation in an ultraviolet wavelength band, a visible light wavelength band, or an infrared wavelength band. The one or more proximity sensors 208 may have any resolution. In some embodiments, one or more optical components, such as a mirror, fish-eye lens, or any other type of lens may be optically coupled to the one or more proximity sensors 208. In embodiments described herein, the one or more proximity sensors 208 may provide image data to the one or more processors 204 or another component communicatively coupled to the communication path 203. In some embodiments, the one or more proximity sensors 208 may also provide navigation support. That is, data captured by the one or more proximity sensors 208 may be used to autonomously or semi-autonomously navigate a vehicle.

The ego vehicle 101 may include one or more vehicle steering sensors 212. Each of the one or more vehicle steering sensors 212 is coupled to the communication path 203 and communicatively coupled to the one or more processors 204. The one or more vehicle steering sensors 212 may include one or more speed sensors or motion sensors for detecting and measuring motion and changes in motion of a vehicle, e.g., the ego vehicle 101. The motion sensors may include inertial measurement units. Each of the one or more motion sensors may include one or more accelerometers and one or more gyroscopes. Each of the one or more motion sensors transforms the sensed physical movement of the vehicle into a signal indicative of an orientation, a rotation, a velocity, or an acceleration of the vehicle. The acquired data from the vehicle steering sensors 212 may be used to determine the vehicle kinematics of the ego vehicle 101. Accordingly, the vehicle steering sensors 212 may be used to collect and generate vehicle control data and vehicle kinematic data. The vehicle control data may include throttle position, brake status, steering angle, and gear selection. The vehicle kinematic data may include velocity, acceleration, position, and orientation.

Each of the vehicle modules may include one or more machine learning algorithms, such as the meta algorithm. The vehicle modules may be trained and provided with machine-learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In ML applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include a generative artificial intelligence algorithm. The generative artificial intelligence algorithm may include a general adversarial network (GAN) that has two networks, a generator model and a discriminator model. The generative artificial intelligence algorithm may also be based on variation autoencoder (VAE) or transformer-based models.

Referring to FIG. 3, an illustrative block diagram for generating personalized ACC settings of the present disclosure is illustrated. The ACC model pool 301 may include one or more default ACC settings 311. In some embodiments, the default ACC settings 311 may not be personalized. The default ACC settings 311 may include a safety limit setting 311a. The safety limit setting 311a may include the desirable factor limitations during any engagement of the ACC. For example, the safety limit setting 311a may include, without limitation, a speed limit, a following distance limit, a braking threshold, and the like.

In an initialized engagement 341, an ACC setting 311b in the ACC model pool 301 may be selected by the online learning ACC system 100 or by the user for the ACC operation. The user may disengage 342 from the ACC setting 311b. For example, the user may not satisfy a following gap (e.g., a 2-second gap) or a following speed. The user may change driving pattern to the following pattern 313. For example, the user may accelerate to reduce the gap from the leading vehicle 103a to reduce the following gap (e.g., a 1.5-second gap), or decelerate to increase the gap from the leading vehicle 103a to increase the following gap (e.g., a 2.5-second gap). The user may then control the ego vehicle 101 moving at the same speed as the leading vehicle 103a (e.g., at 70 miles per hour or 112.7 kilometers per hour). In observation of the disengagement 342 from the selected ACC setting 311b and manually control at a different following pattern, the online learning module 232 may use the following pattern as real-time user inputs to feed the ML module 332 and generate a personalized ACC setting 331 to reflect the following pattern 313 and integrate the personalized ACC setting 331 (e.g., with an individualized desired following gap at certain following speed) to the updated ACC model pool 303. For example, the real-time user inputs may include, without limitation, vehicle speeds, accelerating, decelerating, following distances, lane changing, and vehicle operation mode selection. The online learning ACC system 100 may then reengage the ACC to the newly added personalized ACC setting 331.

Referring to FIG. 4, a flowchart of example generation of personalized ADAS using the online learning module 232 for the ego vehicle 101 of the present disclosure is depicted. The online learning module 232 may model the default ACC settings 311 and the personalized ACC settings 331 to generate one or more default ACC models 411 and personalized ACC models 413 such that based on real-time inputs from a user after disengagement 342 (in FIG. 3), the online learning module 232 can generate a predicted ACC model 413 or default to a closest personalized ACC setting 331 created from the user's previous following patterns 313 (e.g., in FIG. 3) without disengaging from the ACC. The generated predicted ACC model 413 may be added to the ACC model pool 401 to generate an updated ACC model pool 403 for future use.

In some embodiments, the default ACC models 411, personalized ACC models 413 and/or the updated ACC model pool 303 may be fed into the ML module 332 to generate one or more predicted ACC models 413, such as, for example, gap to the neighboring vehicles (e.g., the leading vehicle 103a, the side vehicles 103b in FIG. 1), lane change, and warning time before potential collision. The generated predicted ACC model 413 may be further transmitted to the ego vehicle 101 for real-time interference through the various subsystems of the ADAS as described herein. For example, the ego vehicle 101 may perform personalized real-time interference, such as updating gaps from adjacent vehicles (e.g., the leading vehicle 103a, the side vehicles 103b), assisting lane changing, updating the speed of the ego vehicle 101, and updating warning time for obstacles, collisions, and pedestrians.

In some embodiments, the ACC model pool 401 may include multiple ACC models 411, 413, including generated predicted ACC models 413 and the default ACC models converted from the default ACC settings 311 (as in FIG. 3). The ML module 332 may include the meta algorithm further including an aggregator to aggregate 441 the ACC models 411, 413 in the ACC model pool 401 to predict one or more predicted ACC models 413. In some embodiments, the ML module 332 may predict 442 the predicted ACC model 413 by aggregating 441 one or more ACC models 411,413 associated with the user in the ACC model pool 401. Each ACC model 411, 413 may include a corresponding weight for aggregation purposes, and the predicted ACC model 413 may be predicted 442 by aggregating 441 the ACC models 411,413 based on the corresponding weights. For example, the aggregation 441 may include dividing a sum of products of each ACC model 411,413 and the corresponding weight by a sum of the corresponding weights. In some embodiments, the ML module 332 may be trained 450 by minimizing a difference between the generated predicted ACC models 413 (i.e., personalized ACC model) and the historical user inputs and the user preferences 227 of the user. The ML module 332 may be continuously trained 450 by minimizing the difference between the predicted ACC model and the real-time user inputs.

In some embodiments, the ML module 332 may use one or more neural networks to train an ML algorithm, such as a meta algorithm, to generate one or more personalized ACC settings 331 for generating driver reaction time based on input data including the vehicle speeds, accelerating, decelerating, following distances, lane changing, and vehicle operation mode selection. The neural networks may include an encoder or/and a decoder conjunct with a layer normalization operation or/and an activation function operation. The encoded input data may be normalized and weighted through the activation function before being fed to the hidden layers. The hidden layers may generate a representation of the input data at a bottleneck layer. After delivering neural-network processed data to the final layer of the neural network, a global layer normalization may be conducted to normalize the output, such as predicted driver reaction time. The outputs may be normalized and converted using an activation function for training and verification purposes, as described in detail further below. The activation function may be linear or nonlinear. The activation function may be, without limitations, a Sigmoid function, a Softmax function, a hyperbolic tangent function (Tanh), or a rectified linear unit (ReLU). The neural networks may feed the encoder with historical data from the historical user inputs and user preferences 227. For example, the ML module 332 may train the ML algorithm using historical driving data associated with the current driver in past driving trips, and/or driving data associated with drivers other than the current driver. The one or more neural networks may use regression techniques as described herein. The labeled driver data may be fed to the neural network and the generated personalized ACC settings 331 may be validated using the real-time user inputs sent from the ego vehicle 101 and/or the historical user inputs associated with other similar users. The validation process may include cross-validation.

In some embodiments, The ML module 332 may perform the training 450 in an online learning process. The prediction 442 may generate a reward 432. The ML module 332 may use the predicted ACC model 413 (denoted as Yₜ) to generate an outcome yt. The predicted ACC model 413 may suffer a system loss l(Yₜ, yₜ) and the ACC models 411,413 may suffer a model loss l(fᵢ(t), yₜ) (a convex loss function). The ML module 332 in each training cycle may generate a regret 443 (denoted as R). The goal of the training 450 with the online learning process may be to minimize the regret 443.

In some embodiments, the regret R may be equal to a difference between the sum of the system loss l(Yₜ, yₜ) and the sum of the model loss l(fᵢ(t), yₜ), as in Equation 1.

$${R}_{T} = {\sum }_{t = 1}^{T} l ( {Y}_{t} , {y}_{t} ) - \begin{matrix}inf \\ 1 \leq i \leq M\end{matrix} {\sum }_{t = 1}^{T} l ( {f}_{i} ( t ) , {y}_{t} ) \qquad Equation l$$

where, M is the total number of the ACC models 411,413 in the ACC model pool 401. The online learning process may use different weight approaches, such as an exponentially weighted average algorithm, with initialized weights over the ACC models 411, 413 of wᵢ(0)=1 with i belong to M. Then the predicted ACC model 413 (Yₜ) may be expressed as in Equation 2.

$${Y}_{t} = \frac{{\sum }_{i = 1}^{M} {w}_{i} ( t - 1 ) {f}_{i} ( t )}{{\sum }_{i = 1}^{M} {w}_{i} ( t - 1 )} \qquad Equation 2$$

with a corresponding update wᵢ(t)=wᵢ(t−1)exp(−n1(fᵢ(t), yₜ)), where n is a learning rate. For example, the learning rate in the exponential weighted average algorithm may be (81 nM/T)\hat{ }(0.5). Accordingly, a cumulative expert regret decay may satisfy R_{T}/T≤(InM/(2T))\hat{ }(0.5).

In some embodiments, the online learning process may adopt different cumulative regret R, such as an R following Equation 3.

$${R}_{T} = {\sum }_{t = 1}^{T} l ( {Y}_{t} , {y}_{t} ) - \begin{matrix}inf \\ {w}_{t} ϵΔ M\end{matrix} {\sum }_{t = 1}^{T} l ( {q}_{i} , {y}_{t} ) \qquad Equation 3$$

where, Δ_{M} represents an M-dimensional convex set of the ACC models 411,413, weight w includes the vectors for all the ACC models 411,413 as [w₁(t), w₂(t), . . . , w_{M}(t)], qₜ is an aggregation of prediction, equaling to SUM(wᵢ(t)fᵢ(t)), with i from 1 to M.

During the training, the weight w may be initialized as Δ_{M}, the predict yₜ may be defined as SUM(wᵢ(t−1)fᵢ(t) with i from 1 to M. The weight w can then be updated according to Equation 4 and/or Equation 5.

$${w}_{t + 1} = {w}_{t} - n ∇ l ( {q}_{t} , {y}_{t} ) \qquad Equation 4$$

$${w}_{t + 1} = arg \begin{matrix}min \\ a ∈ Δ M\end{matrix} ‖ {w}_{t + 1} - a ‖ \qquad Equation 5$$

where the learning rate n is defined as n=2R/(GT\hat{ }0.5) and the regret decay is R_{T}/T≤2GR/T\hat{ }(0.5) with R=diameter (Δ_{M}) and subgradient boundary G of subdifferentiable loss. In some embodiments, the subgradient boundary G follows Equation 6.

$$G \geq ‖ ∇ l ( q ( t ) , {y}_{t} ) ‖ \qquad Equation 6$$

In some embodiments, the one or more server modules, such as the ML module 332, may be pre-trained using training data, including ground-truth examples and scenarios where multiple entities (e.g., the ego vehicle 101 and the adjacent vehicles 103) driving on a shared surface, such as road 120, at different road conditions, traffic conditions, and weather conditions, and the example driver may exhibit various driver states and driver reaction time. The pre-training may include labeling the entities, the example driver states, and desirable ACC models and/or ACC settings based on the entities, the example drivers, and the environmental data in the examples and scenarios and using one or more neural networks to learn to predict the desirable and undesirable ACC models and/or ACC settings 331 based on the training data.

After the predicted ACC model 413 is generated (e.g., a loss minimization is achieved), the online learning module 232 may incorporate the predicted ACC model 413 into the updated ACC model pool 403. The predicted ACC model 413 may include a personalized ACC setting 331 associated with a weight. The ADAS module 222 may then use the updated ACC model pool 403, in response to a user's inputs 444, to conduct ACC model selection 445 to find a closet ACC model for the user without disengagement of the ACC.

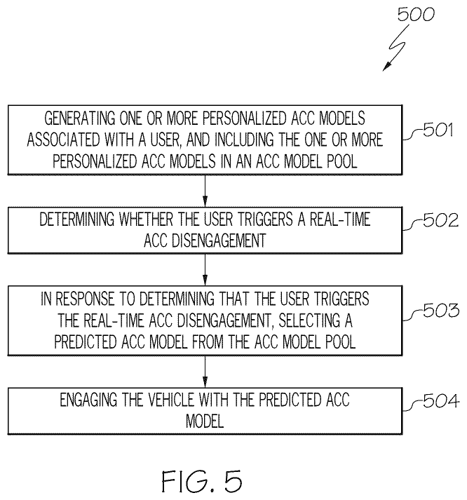

FIG. 5 depicts a flowchart for illustrative steps for method 500 of generating personalized ACC settings of the present disclosure. At block 501, the method 500 may include generating, using a trained meta algorithm and based on historical user inputs and user preferences 227 (in FIG. 2) of a user, one or more personalized ACC models 413 (in FIG. 4) associated with the user, and including the one or more personalized ACC models 413 in an ACC model pool 401 (in FIG. 4) including one or more default ACC models 411 and/or personalized ACC models 413 to obtain an updated ACC model pool 403. At block 502, the method 500 may include determining whether the user triggers a real-time ACC disengagement. At block 503, the method 500 may include, in response to determining that the user triggers the real-time ACC disengagement, selecting, based on real-time user inputs, a predicted ACC model (in FIG. 4) from the updated ACC model pool 403 (in FIG. 4). The predicted ACC model may be one of the one or more personalized ACC models 413 in the updated ACC model pool 403. At block 504, the method 500 may include engaging the ego vehicle 101 (in FIG. 1) with the predicted ACC model.

In some embodiments, each predicted ACC model may be generated by an aggregation of the one or more ACC models 411, 413 (in FIG. 4) in the ACC model pool 401 (in FIG. 4). Each predicted ACC model may be generated by the aggregation of the one or more personalized ACC models 413 associated with the user. The meta algorithm (e.g., included in the ML module 332) may include an aggregator performing the aggregation. Each predicted ACC model 413 may be generated by an aggregation of the one or more ACC models 411,413 in the ACC model pool 401.

In some embodiments, each ACC model 411, 413 of the one or more ACC models 411, 413 may have a corresponding weight, and the one or more ACC models 411, 413 may be aggregated 441 (in FIG. 4) based on the corresponding weights. The aggregation 441 (in FIG. 4) may include dividing a sum of products of each ACC model and the corresponding weight by a sum of the corresponding weights.

In some embodiments, the meta algorithm may be trained by minimizing a difference between the generated personalized ACC models 413 and the historical user inputs and the user preferences 227 of the user (in FIG. 2). The meta algorithm may be continuously trained by minimizing a difference between the predicted ACC model 413 and the real-time user inputs.

In some embodiments, the predicted ACC model 413 may be one of the one or more personalized ACC models 413 (in FIG. 4). The one or more ACC models 411, 413 may include one or more default ACC settings 311 (in FIG. 3).

In some embodiments, each ACC model 411, 413 may include one or more vehicle operation parameters, the one or more vehicle operation parameters comprising vehicle speed, a following distance, a deceleration limit, an acceleration limit, a minimum operation speed, vehicle operation mode selection, weather and road condition adaptation, and vehicle speed adjustments in curves. The vehicle operation parameters of the predicted ACC model may be closer to the real-time user inputs compared with the vehicle operation parameters of the one or more ACC models other than the predicted ACC model. The real-time user inputs may include vehicle speeds, accelerating, decelerating, following distances, lane changing, and vehicle operation mode selection.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for online learning adaptive cruise control (ACC) for driving a vehicle comprising:
one or more non-transitory memories storing an ACC model pool comprising one or more ACC models; and
one or more processors operably causing the system to:
generate, using a trained meta algorithm and based on historical user inputs and user preferences of a user, one or more personalized ACC models associated with the user, and include the one or more personalized ACC models in the ACC model pool;
determine whether the user triggers a real-time ACC disengagement;
in response to determining that the user triggers the real-time ACC disengagement, select, based on real-time user inputs, a predicted ACC model from the ACC model pool including the one or more personalized ACC models; and
engage the vehicle with the predicted ACC model.

2. The system of claim 1, wherein each personalized ACC model is generated by an aggregation of the one or more ACC models in the ACC model pool.

3. The system of claim 2, wherein each personalized ACC model is generated by the aggregation of the one or more personalized ACC models associated with the user.

4. The system of claim 3, wherein the meta algorithm comprises an aggregator performing the aggregation.

5. The system of claim 2, wherein each ACC model of the one or more ACC models has a corresponding weight, and the one or more ACC models are aggregated based on the corresponding weights.

6. The system of claim 5, wherein the aggregation comprises dividing a sum of products of each ACC model and the corresponding weight by a sum of the corresponding weights.

7. The system of claim 1, wherein the meta algorithm is trained by minimizing a difference between the generated personalized ACC models and the historical user inputs and the user preferences of the user.

8. The system of claim 1, wherein the meta algorithm is continuously trained by minimizing a difference between the predicted ACC model and the real-time user inputs.

9. The system of claim 1, wherein the predicted ACC model is one of the one or more personalized ACC models.

10. The system of claim 1, wherein each ACC models comprise one or more vehicle operation parameters, and the vehicle operation parameters of the predicted ACC model are closer to the real-time user inputs compared with the vehicle operation parameters of the one or more ACC models other than the predicted ACC model.

11. The system of claim 10, wherein the one or more vehicle operation parameters comprise a vehicle speed, a following distance, a deceleration limit, an acceleration limit, a minimum operation speed, vehicle operation mode selection, weather and road condition adaptation, and vehicle speed adjustments in curves.

12. The system of claim 1, wherein the real-time user inputs comprise vehicle speeds, accelerating, decelerating, following distances, lane changing, and vehicle operation mode selection.

13. The system of claim 1, wherein the one or more ACC models comprise one or more default ACC settings.

14. A method for online learning adaptive cruise control (ACC) for driving a vehicle comprising:
generating, using a trained meta algorithm and based on historical user inputs and user preferences of a user, one or more personalized ACC models associated with the user, and including the one or more personalized ACC models in an ACC model pool comprising one or more ACC models;
determining whether the user triggers a real-time ACC disengagement;
in response to determining that the user triggers the real-time ACC disengagement, selecting, based on real-time user inputs, a predicted ACC model from the ACC model pool including the one or more personalized ACC models; and
engaging the vehicle with the predicted ACC model.

15. The method of claim 14, wherein:
each personalized ACC model is generated by an aggregation of the one or more ACC models in the ACC model pool;
each personalized ACC model is generated by the aggregation of the one or more personalized ACC models associated with the user; and
the meta algorithm comprises an aggregator performing the aggregation.

16. The method of claim 14, wherein:
each personalized ACC model is generated by an aggregation of the one or more ACC models in the ACC model pool;
each ACC model of the one or more ACC models has a corresponding weight, and the one or more ACC models are aggregated based on the corresponding weights; and
the aggregation comprises dividing a sum of products of each ACC model and the corresponding weight by a sum of the corresponding weights.

17. The method of claim 14, wherein:
the meta algorithm is trained by minimizing a difference between the generated personalized ACC models and the historical user inputs and the user preferences of the user; and
the meta algorithm is continuously trained by minimizing a difference between the predicted ACC model and the real-time user inputs.

18. The method of claim 14, wherein:
the predicted ACC model is one of the one or more personalized ACC models; and
the one or more ACC models comprise one or more default ACC settings.

19. The method of claim 14, wherein:
each ACC models comprise one or more vehicle operation parameters, the one or more vehicle operation parameters comprising vehicle speed, a following distance, a deceleration limit, an acceleration limit, a minimum operation speed, vehicle operation mode selection, weather and road condition adaptation, and vehicle speed adjustments in curves; and
the vehicle operation parameters of the predicted ACC model are closer to the real-time user inputs compared with the vehicle operation parameters of the one or more ACC models other than the predicted ACC model.

20. The method of claim 14, wherein the real-time user inputs comprise vehicle speeds, accelerating, decelerating, following distances, lane changing, and vehicle operation mode selection.
